(19) United States
(12) Patent Application Publication
(10) Pub. No.: US 2007/0177376 A1
(43) Pub. Date: Aug. 2, 2007

(54) Hands-free flashlight

(76) Inventor: Jacquelyn R. Simoni, Glen Ellyn, IL (US)

Correspondence Address: Stephen G. Rudisill;JENKENS & GILCHRIST, A PROFESSIONAL CORPORATION, 225 W. Washington, Ste. 2600, Chicago, IL, 60606-3418, US

(21) Appl. No.: 11/715,176

(22) Filed: Mar. 6, 2007

Related U.S. Application Data
(63) Continuation-in-part of application No. 11/656,844, filed on Jan. 23, 2007.
Application No. 11/656,844 is a continuation-in-part of application No. 11/301,617, filed on Dec. 13, 2005, now Pat. No. 7,185,997.
Application No. 11/656,844 is a continuation-in-part of application No. 10/749,708, filed on Dec. 31, 2003, now Pat. No. 7,008,075.
(60) Provisional application No. 60/638,756, filed on Dec. 23, 2004.
(60) Provisional application No. 60/779,998, filed on Mar. 7, 2006.

(51) Int. Cl. F21L 4/00

(52) U.S. Cl. 362/157

(57) ABSTRACT

The area in front of a person is illuminated without requiring the use of the person's hands, by suspending from the neck of the person a housing containing at least one LED light source emitting a light beam extending forwardly from the person, a battery power supply for the light source, and a switch connected between the light source and the power supply for energizing and de-energizing the light source. The housing is stabilized on the chest of the user by coupling the housing to a stabilizing strap or cord extending around the torso of the user. The stabilizing strap or cord and/or the neck strap or cord may include reflective material for safety purposes, may be adjustable in length, and may include at least one coupling that releases automatically when subjected to a tension force above a selected threshold.

### CROSS-REFERENCE TO RELATED APPLICATION

This invention claims the priority of U.S. Provisional Patent Application Ser. No. 60/779,998, filed Mar. 7, 2006.

This application is a continuation-in-part of pending application Ser. No. 11/656,844 filed Jan. 23, 2007 which is a continuation-in-part of application Ser. No. 11,301,617 filed Dec. 13, 2005, now U. S. Pat. No. 7,185,997, issued Mar. 6, 2007, which claims the priority of U.S. Provisional Patent Application Ser. No. 60/638,756, filed Dec. 23, 2004 and a continuation-in-part of application Ser. No. 10/749,708 filed Dec. 31, 2003, now U.S. Pat. No. 7,008,075, issued Mar. 7, 2006.

### FIELD OF THE INVENTION

The present invention relates generally to a hands-free flashlight and, more particularly, to a lightweight device that is suspended from a person's neck to illuminate a region in front of the person.

### SUMMARY OF THE INVENTION

In accordance with the present invention, there is provided a method and apparatus for illuminating the area in front of a person without requiring the use of the person's hands, by suspending from the neck of the person a housing containing at least one LED light source emitting a light beam extending forwardly from the person, a battery power supply for the light source, and a switch connected between the light source and the power supply for energizing and de-energizing the light source. The housing is stabilized on the chest of the user by coupling the housing to a stabilizing strap or cord extending around the torso of the user. The light source may comprise a plurality of LED light sources.

In one embodiment, the stabilizing strap or cord includes reflective material for safety purposes. The stabilizing strap or cord and/or the neck strap or cord may be adjustable in length, and may include at least one coupling that releases automatically when subjected to a tension force above a selected threshold.

One specific embodiment includes a connector hinged to the housing, and a flexible loop is coupled to the connector for suspending the housing from the neck of the person so that the housing is located in front of the chest of the person. The housing is pivotable relative to the connector to permit the light beam from the light source to be directed forwardly from the person through a preselected range of angles both above and below a horizontal axis. The hinge between the connector and the housing may restrict the movement of said housing after it has been positioned to direct the light beam at a desired angle.

### BRIEF DESCRIPTION OF THE DRAWINGS

The invention may best be understood by reference to the following description taken in conjunction with the accompanying drawings, in which:

FIG. 1A is a front perspective view of a person wearing a hands-free flashlight, according to one embodiment of the present invention, with the light beam directed slightly downwardly,

FIG. 1B is the same as FIG. 1A but with the flashlight the light beam directed upwardly,

FIG. 2 is an enlarged perspective view of the flashlight shown in FIGS. 1A and 1B,

FIG. 3 is a bottom perspective view of the flashlight of FIGS. 1A and 1B,

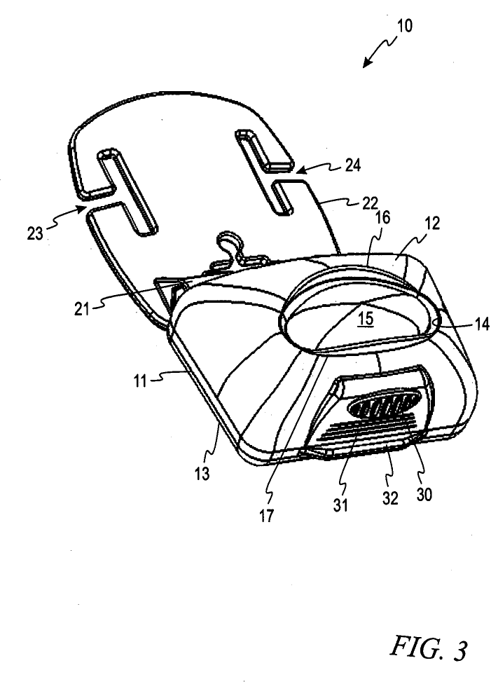

FIG. 4 is a rear perspective view of the flashlight of FIGS. 1A and 1B,

FIG. 5 is a perspective view of the interior of the rear section of the flashlight of FIGS. 1A and 1B,

FIG. 6 is the same perspective view shown in FIG. 5 with the batteries removed,

FIG. 7 is a perspective view of one side of the circuit board contained in the front section of the flashlight of FIGS. 1A and 1B,

FIG. 8 is a perspective view of the other side of the circuit board contained in the front section of the flashlight of FIGS. 1A and 1B,

FIG. 9 is an electrical schematic of the electrical circuit contained in the flashlight of FIGS. 1A and 1B,

FIGS. 10 and 11 are plan views of two parts of a two-part adjustable band for use with the flashlight of FIGS. 1-9,

FIG. 12 is a perspective view of the flashlight shown in FIGS. 1A-1C with the housing attached to the clip with an orientation inverted from that shown in FIGS. 1A-1C,

FIG. 13 is a front perspective view of a person wearing a hands-free flashlight, according to a modified embodiment of the invention, and

FIG. 14 is a perspective view of a modified embodiment of an adjustable band for use with the flashlight of FIG. 13.

### DETAILED DESCRIPTION OF THE ILLUSTRATED EMBODIMENTS

Although the invention will be described next in connection with certain preferred embodiments, it will be understood that the invention is not limited to those particular embodiments. On the contrary, the description of the invention is intended to cover all alternatives, modifications, and equivalent arrangements as may be included within the spirit and scope of the invention as defined by the appended claims.

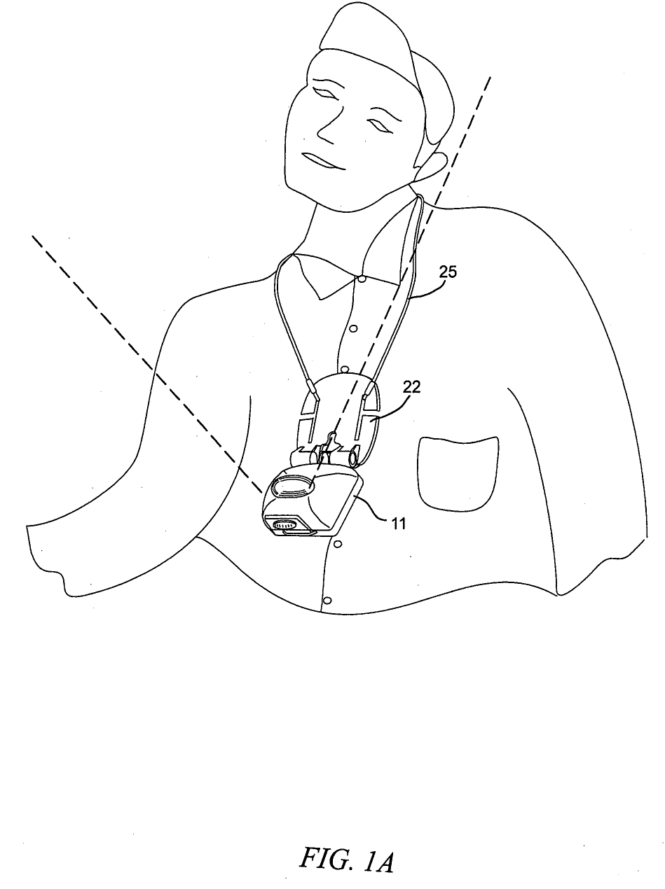

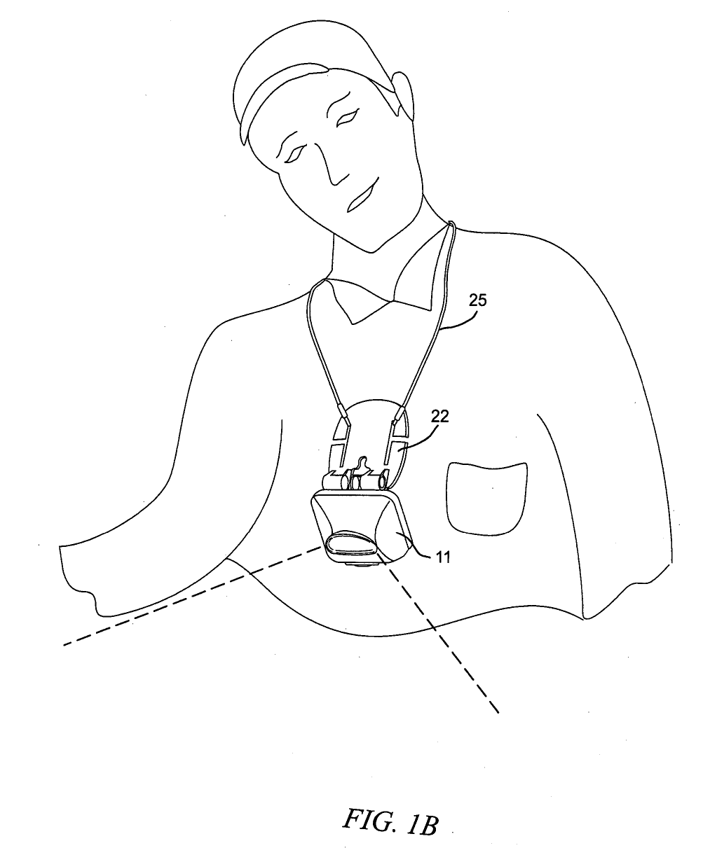

Turning now to the drawings, and referring initially to FIGS. 1A and 1B, a flashlight 10, according to one embodiment of the present invention, includes a housing 11 made of molded plastic material and adapted to be suspended from the neck of a user (see FIGS. 1A and 1B). By suspending the housing 11 from the neck of the user so that the housing rests against the chest of the user, the light beam produced by the light source in the housing remains relatively stable. For example, the direction of the light beam does not move with movements of the user's head. Because the housing 11 can be pivoted about a horizontal axis (as described in detail below), the elevation angle of the beam may be adjusted to direct the beam downwardly (as depicted in FIG. 1A) or upwardly (as depicted in FIG. 1B) from horizontal. Thus, the light beam may be directed onto different objects located at different elevations, or to illuminate regions at varying distances in front of the user.

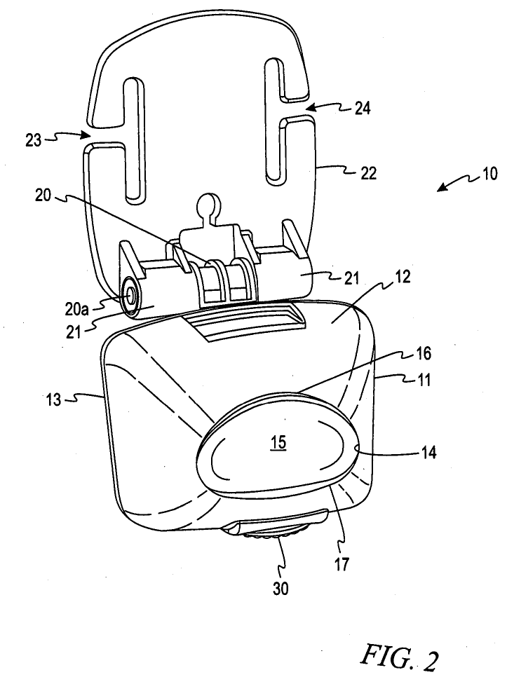

As can be seen in FIG. 2, the housing 11 includes a front section 12 and a rear section 13 which mate to form an internal cavity to contain the components described below. The front section 12 and the rear section 13 are molded, along their respective joining internal edges, to form a snap fitting of the kind well known in the state of the art. The front and rear sections 12 and 13 may thus be easily taken apart for access to the internal cavity. Alternatively, the two parts may be joined by an integral “living hinge” on one side and an integral snap-type latch on the opposite side to hold the two sections 12 and 13 together.

The front housing section 12 forms a substantially oval aperture 14 for receiving a translucent or transparent lens 15 through which light from sources inside the housing can be transmitted forwardly from the housing. In the illustrative embodiment, the front housing section forms upper and lower rims 16 and 17 along the upper and lower edges of the aperture 14 to prevent light from being transmitted straight up or down from the aperture. The ends of the aperture, however, are unobstructed so that light can be transmitted laterally directly from the end edges of the aperture 14.

The illustrative flashlight 10 forms a unit that may be made small and compact for ease of packaging, handling and use, and to reduce cost. For example, one preferred embodiment uses a housing of approximately 2 ⅛ inches in the x dimension, 1 5/8 inches in the y dimension and approximately 7/8 inches thick or deep. It will be understood, however, that the dimensions of the housing may be varied for different shapes and designs.

A hinge section 20 is molded as an integral part of the rear housing section 13, and mates with a complementary hinge section 21 formed as an integral part of an attachment clip 22. A pin 20a is inserted through the two hinge sections 20 and 21 to hold them together while permitting rotational movement of the two hinge sections relative to each other. The opposed surfaces of the two hinge sections 20 and 21 that move relative to each other are roughened to increase the friction between those surfaces, to inhibit swinging movement of the housing 11 and thereby improve the stability of the light beam. Thus, the angular position of the housing 11 can be adjusted relative to the clip 22 to optimize the illuminated area in front of a person wearing the flashlight, and the housing will remain in the selected position. The hinge also permits the housing to be rotated 180 degrees so that it lies flat against the clip 22 before the clip is attached to the loop used to suspend the housing from the neck of a user, thereby providing a shorter unit.

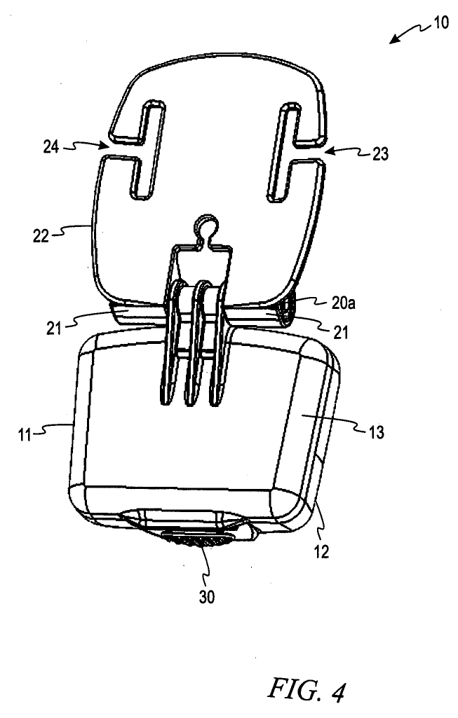

The clip 22 also forms a pair of T-shaped slots 23 and 24 opening through opposite edges of the clip for receiving and holding a loop 25 (see FIGS. 1A and 1B) adapted to fit around the user's neck. As can be seen in FIG. 4, the housing 11 depends from the bottom edge of the clip 22, and the lens 15 is located toward the lower end of the housing 11, so that the light emanates from the lens a couple of inches or more below the loop 25. The loop 25 can be made of a variety of different materials, such as those commonly used to suspend a pair of glasses from the neck of a person. The loop is preferably adjustable to permit the housing 11 to be positioned at different elevations on the user's chest, and to accommodate users of different sizes. The loop may also be made of an elastic material to facilitate the application to, and removal from, the user's neck.

An on/off switch 30 is located on the bottom of the front housing section 12. A pattern area 31 and a lip 32 are molded into the housing to provide finger and thumb surfaces that can be felt and gripped when opening the housing 11 to change batteries or to access the interior of the housing for other purposes such as to replace the light sources.

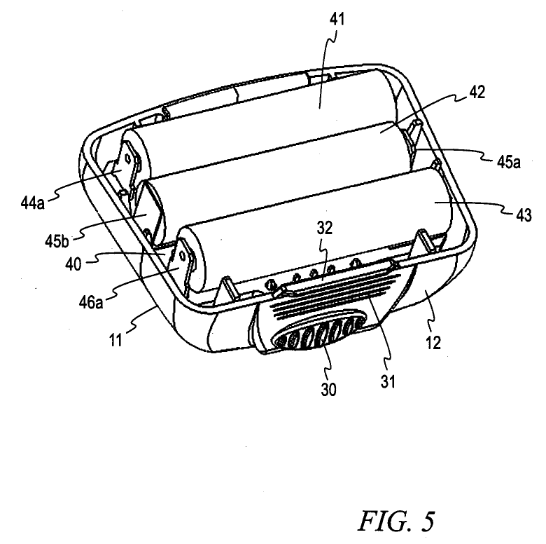

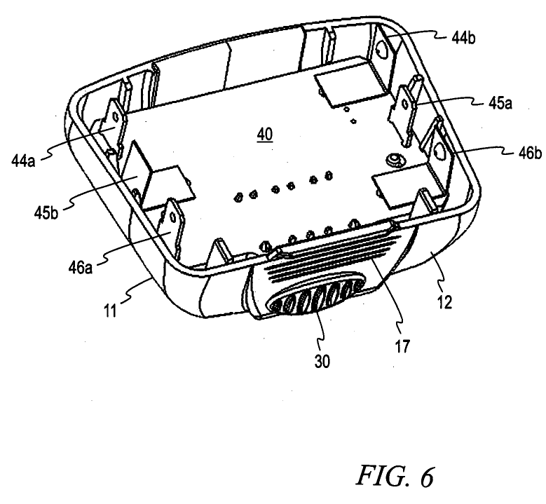

FIG. 5 shows the interior of the front housing section 12, which contains an internal circuit board 40. Three 1.5-volt alkaline batteries 41, 42 and 43 are mounted on the rear side of the circuit board 40, making contact with three pairs of conventional battery terminals 44a and 44b, 45a and 45b, and 46a and 46b attached to the circuit board 40. FIG. 6 is the same view as FIG. 5 with the batteries removed to more clearly show the battery terminals and their attachments to the circuit board 40.

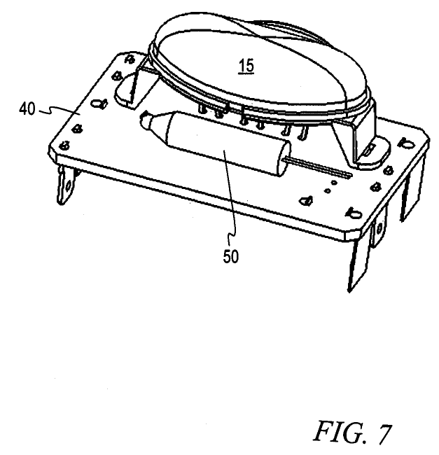

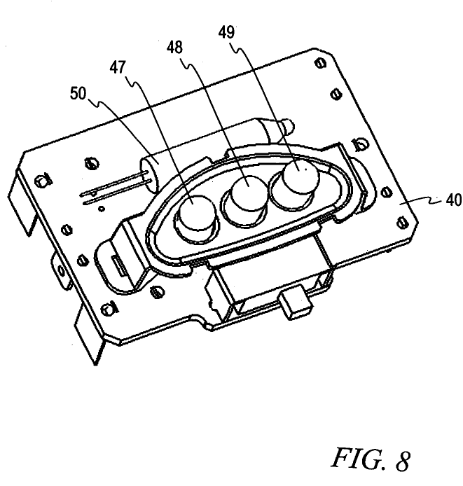

FIGS. 7 and 8 show the circuit board 40 without the housing. It can be seen that the lens 15 is mounted on the front side of the board 40, and three light emitting diodes (LEDs) 47, 48 and 49 are mounted on the board directly below the lens 15 (see FIG.8). The center LED 48 is positioned to emit a light beam directed straight forward, while the two side LEDs 47 and 49 are positioned to emit light beams directed slightly outwardly. The LEDs preferably emit white light with about 12,000 to 14,000 millicandelas. This combination of light beams is capable of illuminating an area extending as far as 200 feet in front of the user, with a beam width that is at least 5 feet wide at a distance of about 10 feet in front of the user. It will be understood that the LEDs may be varied in both number and size, but it is preferred that the source or sources be sufficient to illuminate an area extending at least 10 feet, most preferably at least 20 feet, in front of the user.

An incandescent lamp 50 is also mounted on the front side of the board 40, for a purpose to be described below. Finally, the on/off switch 30 is also mounted on the front side of the board 40, adjacent the bottom edge of the board.

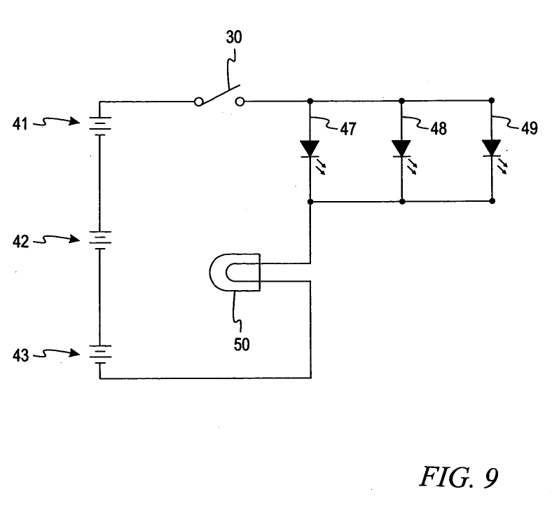

FIG. 9 is a schematic diagram of the electrical circuit provided the circuit board 40 to interconnect the various components mounted thereon. The three 1.5-volt alkaline batteries (AAA) 41-43 are electrically connected in series to provide 4.5 DC volts to the circuit through a sliding SPST on/off switch 30. The three white LEDS 47-49 are connected in parallel with each other and in series with the switch 30 so that all three LEDs are illuminated when the switch 30 is turned closed. The incandescent, tungsten-filament lamp 50, of the kind used for ornamental lighting, e.g., as in Christmas tree light string, is used as a constant current ballast resistor in the circuit. The current flowing through the tungsten filament of the lamp 50 varies with the available voltage from the batteries 41-43 due to the positive temperature coefficient of the filament, thereby providing a substantially constant amount of current to the LEDs 47-49. By using the incandescent lamp 50 as a variable resistor, the life of the batteries is extended and the intensity of the white LEDs 47-49 is more uniform over the life of the batteries 41-43.

If desired, a variable impedance may be added to the circuit to permit the intensity of the light beam to be adjusted by a manually operated adjustment device (e.g., a knob) accessible on an exterior surface of the housing. A mechanically adjustable reflector may also be used to permit the light beam width to be adjusted.

If desired, red or green LEDs or lenses may be used instead of white LEDs and a clear lens. Red and green light assists night vision (e.g., for hunting), and animals are more comfortable with green light. Combinations of LEDs of different colors may also be used, with one or more switches to permit selection of a light beam of the desired color.

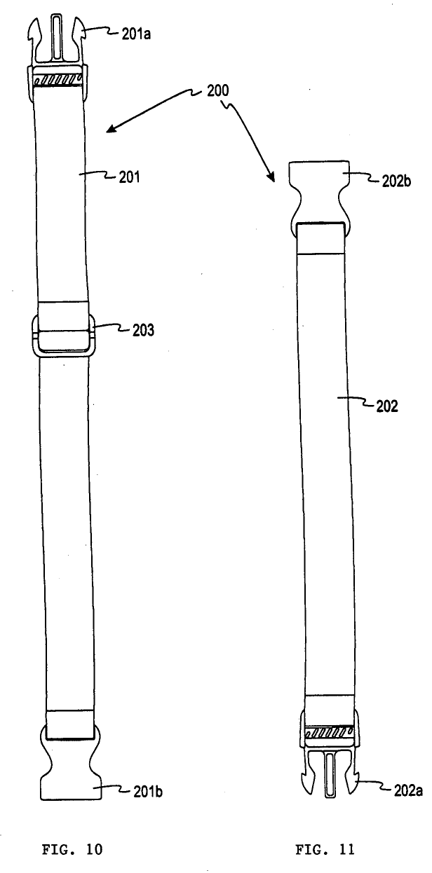

FIGS. 10 and 11 illustrate a two-part band 200 that can be sold with the flashlight to accommodate different applications and users of different sizes. The band 200 comprises two adjustable bands 201 and 202 of different lengths, with mating male and female clip elements 201a, 201b and 202a, 202b attached to opposite ends of the respective bands. The male element 201a or 202a of either band 201 or 202 also mates with the female element 201b or 202b of the other band 201 or 202, i.e., the male elements 201a and 202a are interchangeable, and the female elements 201b and 202b are also interchangeable. The band 201 is also made adjustable in length by using a glide/slide 203 that allows the band to double up to shorten the band, or to be extended to a single layer to lengthen the band.

The flashlight may be used with either band 201 or 202 alone, or the two bands may be connected in series with each other, as illustrated in FIG. 10, to form a larger-diameter band. Thus, the two separate bands 201 and 202, combined with the adjustability of each band, permits the user to choose a desired size from a wide range of possibilities. For example, having a single package that accommodates all sizes of users and all applications reduces inventory, shelf space and manufacturing costs.

Any desired fabric may be used to form the bands 201 and 202, such as cotton, nylon, polyester or polypropylene. The bands 201 and 202 are preferably made of an elastic material.

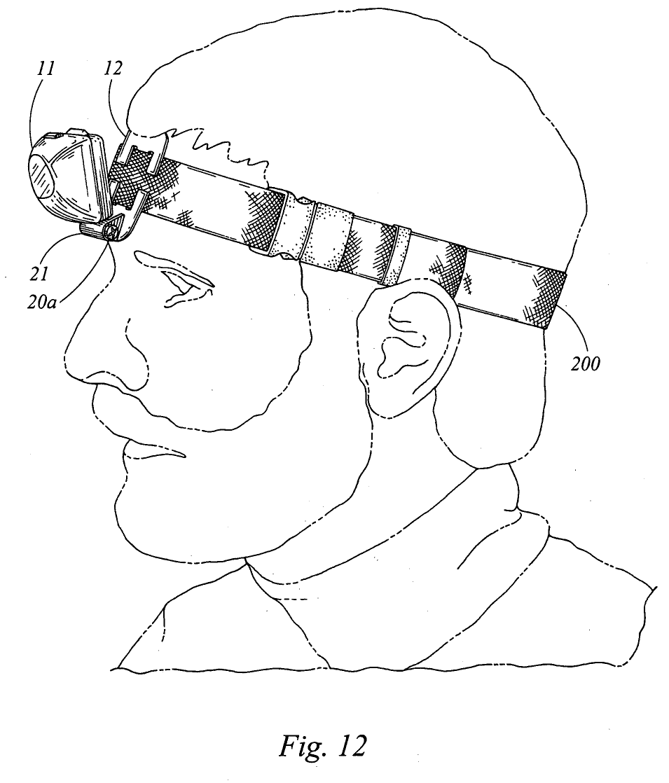

FIG. 12 illustrates how the housing 11 and attachment clip 22 can be adapted for interchangeable use as a head lamp. The housing 11 is attached to the clip 22 with an orientation inverted from that shown in FIGS. 1 and 2, so that the back of the housing 11 can be pivoted flush against the front surface of the clip 22. The hinged connection between the housing 11 and the clip 22 permits the housing to be easily tilted to different angles, such as the angle illustrated in FIG. 12, to direct the light beam forwardly or downwardly at different angles to illuminate desired objects or areas. For example, the light beam can be directed downwardly onto a book for reading, or straight forward for walking.

The orientation of the housing 11 and clip 22 illustrated in FIG. 12 is achieved by removing the screw 20a that extends through the holes in the integral hinge portions of the housing and clip. The housing is inverted and then re-attached to the clip with the hinge screw 20a and a mating nut that is threaded onto the free end of the screw. In the embodiment illustrated, both the screw head and the nut are recessed in countersunk portions of the end surfaces of the hinge section 21.

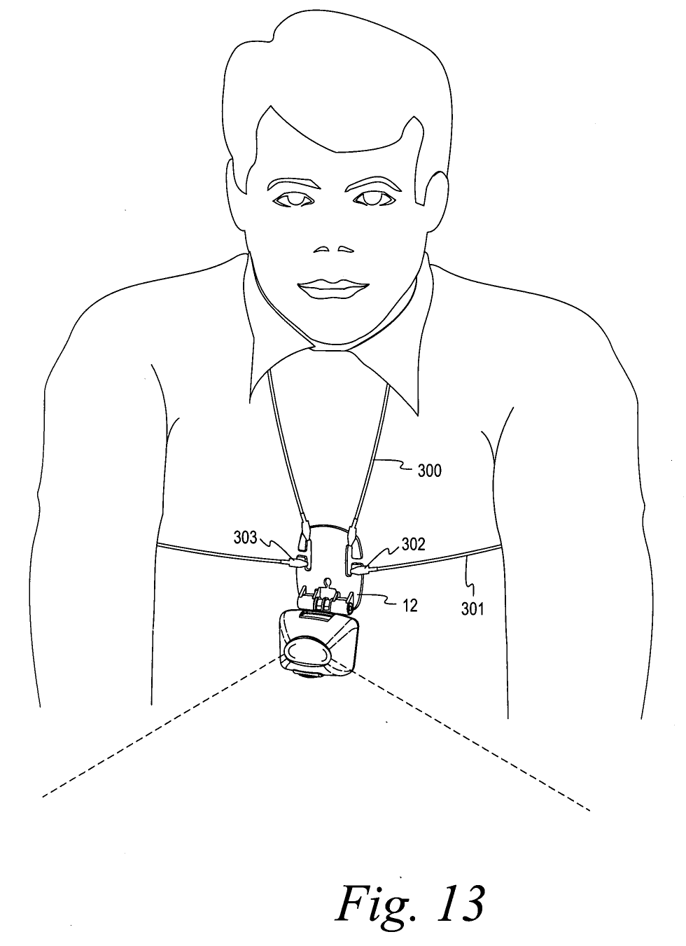

FIG. 13 illustrates a modified embodiment that includes both a neck cord 300 and an auxiliary stabilizing cord 301 extending around the torso of the user to hold the flashlight against the chest of the user when the user is active, e.g., during jogging biking or any activity that might make the light swing or bounce up and down. The stabilizing chest cord restrains the light from bouncing up and down when the user is jogging or running and inhibits the light from swinging when a person is biking, for instance. Although the stabilizing cord tends to hold the clip 22 flat against the chest of the user, the light is still free to be pivoted up and down so the light can be placed where the user wants it.

Opposite ends of the stabilizing cord 301 are equipped with fasteners 302 and 303 for attaching the ends of the cord 301 to tabs 304 and 305 on opposite sides of the clip 22. If desired, the auxiliary cord 300 may be equipped with a length-adjusting device to permit the cord to drawn snugly against the torso of the user. For added safety, the stabilizing chest cord 301 can be made reflective so the person wearing the light is more visible from behind for safety purposes. A wider reflective strap can be used to increase visibility to traffic. To further increase visibility from behind, a second light, blinking or constantly on, can also be used.

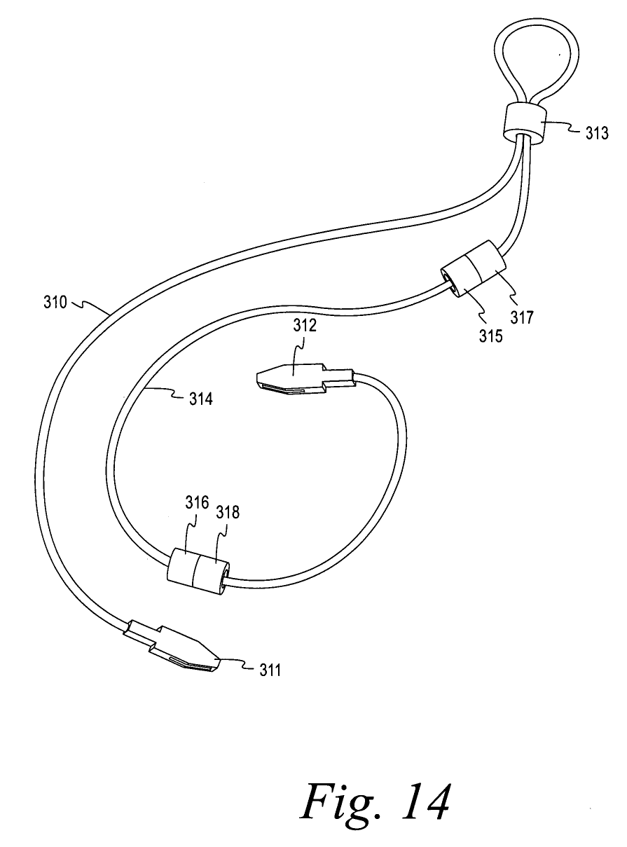

FIG. 14 illustrates a modified adjustable cord 310 for use with the flashlight shown in FIG. 13. Opposite ends of the cord 310 are equipped with fasteners 311 and 312 for attaching the ends of the cord to tabs on opposite sides of the clip 22. A central portion of the cord 310 is passed through a sliding friction grip 313 to permit easy adjustment of the lengths of the two free ends of the cord 310, e.g., to allow raising and lowering of the light unit. This adjustability may also be used to fit the contours of the user better, making use of the light more comfortable, especially for women.

In addition, the cord 310 includes a detachable segment 314 equipped with fasteners 315 and 316 that mate with compatible fasteners 317 and 318 on adjacent sections of the cord to permit the segment 314 to be inserted into, or removed from, the cord 310 to accommodate different sizes of users, different types and/or layers of clothing, or different applications. The fasteners 315, 317 and 316, 318 may also function as safety releases that automatically disengage when subjected to a predetermined tension, to prevent the cord from being accidentally drawn tightly around the neck of the user. For example, magnetic or hook-and-loop couplings may be designed to decouple automatically when subjected to tension forces above a selected threshold. The cord 310 can be easily made as long or short as desired, and can be hung from a hook, a tree branch or the center of a tent. In addition, one of the fasteners 315, 317 and 316, 318 may be used as a snap that makes it easier to take off and put on the light.

This adjustable cord 310 may be used for either or both of the neck cord 300 and the auxiliary cord 301 shown in FIG. 13. For the neck cord, the adjustability permits the light to be raised and lowered, while adjustability of the stabilizing cord permits the cord to be tightened and loosened. If desired, either or both of these cords may be made of a resilient (elastic) material. The fasteners 311 and 312 may be rubber or elastic loops that attach the cord 310 to the stabilizing clip plate 12. The size and/or shape of the rubber or elastic loops can be made adjustable or deformable so that the cord can be more easily removed from the clip plate, or the size and shape may be fixed for tight frictional engagement with the tabs on the clip plate. Fasteners similar to those used on universal eyeglass cords may be used.

While particular embodiments and applications of the present invention have been illustrated and described, it is to be understood that the invention is not limited to the precise construction and compositions disclosed herein and that various modifications, changes, and variations may be apparent from the foregoing description without departing from the spirit and scope of the invention as defined in the appended claims.

What is claimed is:

1. A method of illuminating the area in front of a person without requiring the use of the person's hands, comprising:
suspending from the neck of the person a housing containing at least one LED light source emitting a light beam extending forwardly from said person, a battery power supply for said light source, and a switch connected between said light source and said power supply for energizing and de-energizing said light source, said housing being shaped to rest against the chest of said person so that the direction of said light beam remains substantially stable, and
stabilizing said housing on the chest of the user by coupling said housing to a stabilizing strap or cord extending around the torso of said user.

2. The method of claim 1 wherein said stabilizing strap includes reflective material.

3. The method of claim 1 wherein said housing is suspended in a manner that inhibits swinging movement of said housing.

4. The method of claim 1 in which said stabilizing strap is adjustable in length.

5. The method of claim 1 in which said housing is suspended from the neck of said person by a strap or cord that includes at least one coupling that releases automatically when subjected to a tension force above a selected threshold.

6. The method of claim 1 wherein said housing is connected to said stabilizing strap or cord by a clip that is connected directly to said stabilizing strap so that said clip is held flat against the chest of the user, and said housing is pivotally connected to said clip to permit adjustment of the elevation angle of the light beam emitted from said housing.

7. A hands-free flashlight for illuminating the area in front of a person without requiring the use of the person's hands, comprising:
a housing containing at least one LED light source emitting a light beam extending forwardly from said person, a battery power supply for said light source, and a switch connected between said light source and said power supply for energizing and de-energizing said light source, said housing being shaped to rest against the chest of said person so that the direction of said light beam remains substantially stable,
a neck strap or cord coupled to said housing for suspending said housing from the neck of the person, and
a stabilizing strap or cord coupled to said housing and adapted to extend around the torso of the person for stabilizing said housing on the chest of the user

8. The hands-free flashlight of claim 7 wherein said stabilizing strap or cord includes reflective material.

9. The hands-free flashlight of claim 7 wherein said housing is suspended in a manner that inhibits swinging movement of said housing.

10. The hands-free flashlight of claim 7 in which said stabilizing strap is adjustable in length.

11. The hands-free flashlight of claim 7 in which said housing is suspended from the neck of said person by a strap or cord that includes at least one coupling that releases automatically when subjected to a tension force above a selected threshold.

12. The hands-free flashlight of claim 7 wherein said housing is connected to said stabilizing strap or cord by a clip that is connected directly to said stabilizing strap so that said clip is held flat against the chest of the user, and said housing is pivotally connected to said clip to permit adjustment of the elevation angle of the light beam emitted from said housing.

13. The hands-free flashlight of claim 12 in which said stabilizing strap or cord is coupled to said housing via said clip.
